(19) United States
(12) Patent Application Publication
(10) Pub. No.: US 2007/0056531 A1
(43) Pub. Date: Mar. 15, 2007

(54) Pet exercise and entertainment device

(76) Inventor: Jack W. Renforth, Aurora, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/305,710

(22) Filed: Dec. 16, 2005

Related U.S. Application Data
(60) Provisional application No. 60/717,681, filed on Sep. 15, 2005.

(51) Int. Cl. A01K 27/00

(52) U.S. Cl. 119/859

(57) ABSTRACT

An animal or pet exercise and entertainment apparatus includes a housing, an attachment device operably connecting to the housing for connecting the apparatus to an animal, and at least one light emitting unit for projecting a light onto a nearby surface to acquire an animal's interest. The apparatus also includes a control unit which is operably connected to the light emitting unit for controlling the operation of the apparatus and the light emitting unit. The control unit also may be used for selecting various modes of operation of the light emitting unit, such as random cycle, timed cycle, repetitive cycle, and target cycle. The apparatus includes a light emitting unit operably connected to a selectable lens unit which modifies the emitted light's projected shape, color, or angular direction to optimize animal interest with the projected light.

### CROSS-REFERENCE TO RELATED APPLICATIONS

This application claims the benefit under 35 U.S.C. § 119(e) to provisional patent application No. 60/717,681, filed Sep. 15, 2005 and entitled “Pet Exercise and Entertainment Device”, the disclosure of which is hereby incorporated herein in its entirety.

### FIELD OF THE INVENTION

This invention generally relates to animal exercise and entertainment, and in particular to providing an optical stimulus to cause an animal to move.

### BACKGROUND OF THE INVENTION

For some animal owners, quality time spent with a domesticated animal is often overtaken by other priorities and activities. Additionally, an owner's commitment toward providing routine exercise and entertainment for his pet may be difficult to maintain. When an owner does commit the time, the burden usually falls upon the owner to create an activity to exercise and entertain their pet.

Depending on the activity created, the pet's interest may be short-lived or long-lasting. Moreover, the type or breed of a pet may determine or contribute to the length of interest (if any) in the activity. For example, cats have been known to take interest in chasing moving objects. Certain dog breeds, such as Jack Russell terriers, miniature dachshunds, or other small breeds that are typically energetic, including young developing puppies, are similarly often interested in chasing objects. Likewise, numerous types of animals, pets, or breeds of animals may be entertained by moving objects.

Lights projected on a surface have often served as a moving object for animals to chase. Lights often prove to be elusive to the animal increasing the desire to chase. Projected lights are also non-destructible, whereas some animal toys such as balls and ropes may exhibit wear.

Penlights and hand-held laser lights have provided animal entertainment, but typically only when operated by a person. What is needed is an entertainment and/or exercise device that may operate with a minimum amount of human interaction.

### BRIEF SUMMARY OF THE INVENTION

An exemplary embodiment of the present invention takes the form of an animal exercise or entertainment device that is attached to an animal and includes at least one light projected onto a surface for the animal to chase. The embodiment includes a housing for securing and protecting the light. Control of the light may be remotely or manually operated. In the exemplary embodiment the device may be removably secured to the animal by various means.

Another embodiment of the present invention takes the form of an illuminating device which includes a housing, a light producing unit operably connected to the housing and operative to produce a light visible to an animal associated with the apparatus and an attachment device, wherein the housing operably connected to the attachment device.

Still in another embodiment of the present invention takes the form of an animal exercise device including an animal collar, a housing removably secured to the animal collar, and at least one light emitting unit operably coupled to the housing, the light emitting unit operative to project a focused beam of light onto a surface.

Yet another embodiment of the present invention takes the form of a method for manufacturing an animal exercise device, including the operations of providing a housing, providing at least one light emitting unit operably connected to the housing and operative to project a light visible to an animal onto a surface, providing a connector operably connected to the housing to attach the housing to an animal attachment device, providing control of the at least one light emitting unit, thereby exposing the animal to the light projected onto the surface.

### BRIEF DESCRIPTION OF THE DRAWINGS

FIG. 1 is a perspective view illustrating a first embodiment of the present invention in an exemplary environment.

FIG. 2 is a perspective view of the first embodiment of the present invention.

FIG. 3 is an exploded view of the first embodiment of the present invention.

FIG. 4 is a top plan view one of a second embodiment of the present invention.

FIG. 5 is a perspective view of the embodiment of FIG. 4, illustrating multiple light projections.

FIG. 6 is a longitudinal cross-section view of the embodiment of FIG. 4, taken along 6-6 of FIG. 4.

FIG. 7 is top plan view of a third embodiment of the present invention.

FIG. 8 is a perspective view of the embodiment of FIG. 7.

FIG. 9 is a cross-sectional view of the embodiment of FIG. 7 along line 9-9 in FIG. 7.

FIG. 10 is perspective view of a fourth embodiment of the present invention.

FIG. 11 is a cross-sectional view of the embodiment of FIG. 10 taken along line 11-11 in FIG. 10.

FIG. 12 is a perspective view illustrating a fifth embodiment of the present invention in an exemplary environment.

FIG. 13 is a top plan view of a fifth embodiment of the present invention.

FIG. 14 is a side plan view of the fifth embodiment of the present invention.

FIG. 15 is a back plan view of the fifth embodiment of the present invention.

FIG. 16. is an exploded view of the fifth embodiment of the present invention.

### DETAILED DESCRIPTION OF THE INVENTION

One embodiment of the present invention takes the form of a device for exercising and entertaining an animal. The embodiment, in general, includes a device that may be attached to an animal. The device may emit a light onto a surface visible to the animal. Subsequent movement by the animal or reaction to the light generally re-locates the light's position on the surface. The re-location of the light may be on to a nearby or adjacent surface. The presence and/or motion of the light may capture the animal's attention and/or interest, potentially causing the animal to interact with (i.e., chase) the light. This operation and/or action of the light's re-positioning may be repeated indefinitely, until the animal's interest has diminished or until a person terminates the operation. Some animals or pets may be more prone to a more erratic or energetic response than others. The embodiment may be affixed (removably or permanently) to an article worn by the animal (such as a collar) or, optionally, directly to the animal.

Another embodiment may include a housing. The housing encloses or encases components of the pet exercise device, and additionally may secure and protect various components of the device. The device may also include a light emitting unit to produce and/or project light, typically onto a surface visible to an animal. The light emitting unit and other components related to the present embodiments are generally encased within the housing. However, alternate embodiments of the invention may place the light emitting unit, as well as other components, outside the housing. Additionally, in the present embodiment, the device may be attached (removably or fixedly) to animal collars, backpacks, harnesses, capes, bandanas, or other articles worn by the animal (collectively, an “animal attachment device”). Thus, in operation the device may be removably secured to the animal or pet and project a light within an animal's field of view.

In yet another embodiment of the present invention, the light emitting unit generally is a light emitting diode (LED), laser, infrared LED, incandescent bulb, or similar component. The light emitting unit may include circuitry for operating the device, such as timing light emissions, coordinating the operation of multiple light emitting units, power management, and other control functions. Such circuits may employ numerous operational elements (i.e., resistors, capacitors, flip-flops, and other analog and/or digital elements) to perform various functions described herein, such as control functions. In general, the light emitting unit may include electronics or circuits to permit dynamic operation of the embodiment. For instance, the light emitting unit may be remotely controlled, or a switch may be provided on the device for operating the light. In yet another embodiment, multiple light emitting units may be provided, with each light possibly selectively controllable to likely acquire of the interest of a pet.

In still another embodiment of the present invention, the housing may be a fixed or rigid structure sized appropriately to be affixed to the animal or the animal attachment device worn by the animal. Alternately, the housing may be made of an at least partially flexible material to provide enhanced adaptability to the shape of, or attachment points of, the animal attachment device. In yet other embodiments, attachment points modified from the housing or adapted to affix to the housing are included for adapting the device to the animal attachment device. Connectors of various structures and materials may be also be used to attach the device, such as hook and loop fasteners (e.g., VELCRO), adhesive tape, tie strings, plastic ties, grommets, eyelets, padeyes, molded hooks, and the like.

In still another embodiment of the present invention, the pet exercise device may utilize a timing routine to controllably operate the light emitting units based (for example) on time lapsed during the embodiment's operation. In another embodiment, a duration of display of one or more lights may be selected by the operator of the device. In yet other embodiments, a random sequence of lights are emitted, possibly for a random period of time. Any or all embodiments discussed herein may include multiple lights directed at different angles from the housing. Alternately, a feature for mechanically or electronically selecting or adjusting the light emitting unit, or aperture through which the light is emitted, may be included.

In certain embodiments, the color and shape of the projected light may be selectable either remotely or manually. In yet other embodiments of the invention, a sound unit may optionally be provided to produce a sound. Such a sound may, for example, alert the pet that a light is about to be displayed, possibly conditioning the pet over time to the light and further increasing pet interest. Alternately, the embodiment may occasionally or intermittently produce a sound to alert a person that the embodiment is active. As yet another option, the embodiment may emit a noise when the embodiment begins to cease operation.

The methods and devices disclosed herein may be used with a variety of animals including domesticated pets, such as cats, dogs, ferrets, and the like. Inasmuch as the present invention may have many variations, modifications, and changes in detail, it is intended that the subject matter discussed above and shown in the accompanying drawings be interpreted as illustrative and not in a limiting sense.

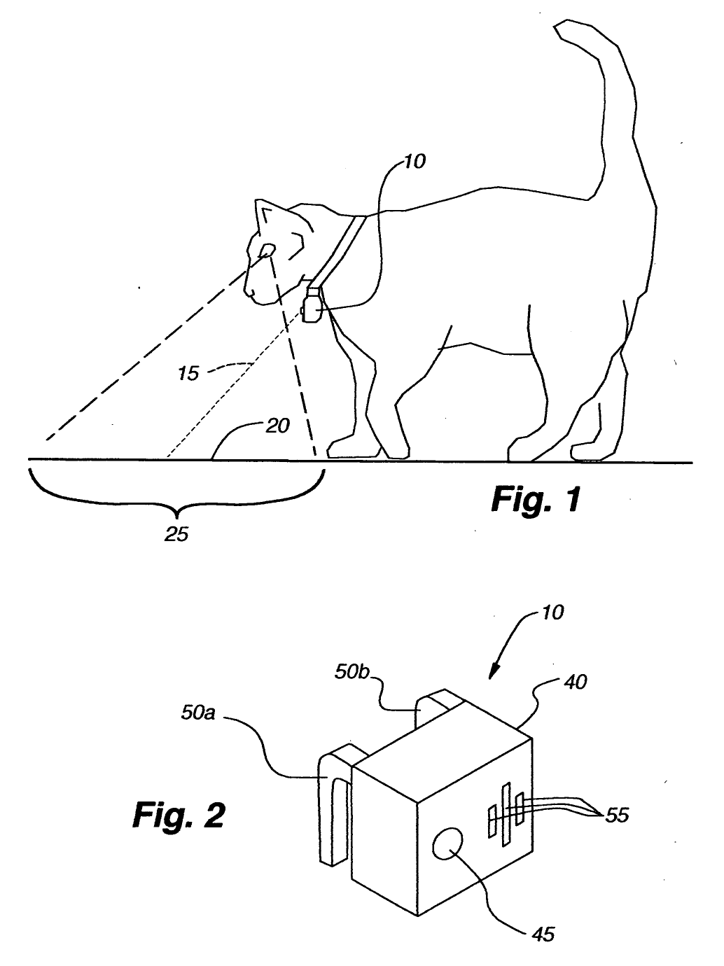

Referring now to the drawings, FIG. 1 illustrates a pet exercise and entertainment device 10 worn by a cat, projecting a light 15 on a surface 20 within a field of view 25 of the cat. A pet wearing the device may observe the projected light 15 on the nearby surface 20. Movement by the pet typically causes relocation of the light 15, and thereby motion, insofar as the device 10 is in an at least partially fixed relationship with the animal wearing the device. Pet interest is generally obtained once the simulated motion is within a field of view of the pet 25. Thus, the projected light's appearance and/or motion may at least partially determine continued pet interest and subsequent reaction.

In FIG. 2, the pet entertainment and exercise device 10 is shown in more detail. The device may include a housing 40 for enclosing various components of the device 10. Housing 40 typically contains at least one light aperture 45 which facilitates light projection from the device 10. The device housing 40 further may include connection points 50a, 50b (for example, in the form of hooks), for removably or permanently securing device 10 to the pet. Usually, the connection points 50a, 50b are adapted for attachment to an animal attachment device, such as a collar or other article worn by a pet. The device 10 optionally may be configured to attach directly to the pet without the aid of an animal attachment device. In certain embodiments of the present invention, an audio opening or sound aperture 55 is provided within the housing 10 for emitting a sound generated by device 10.

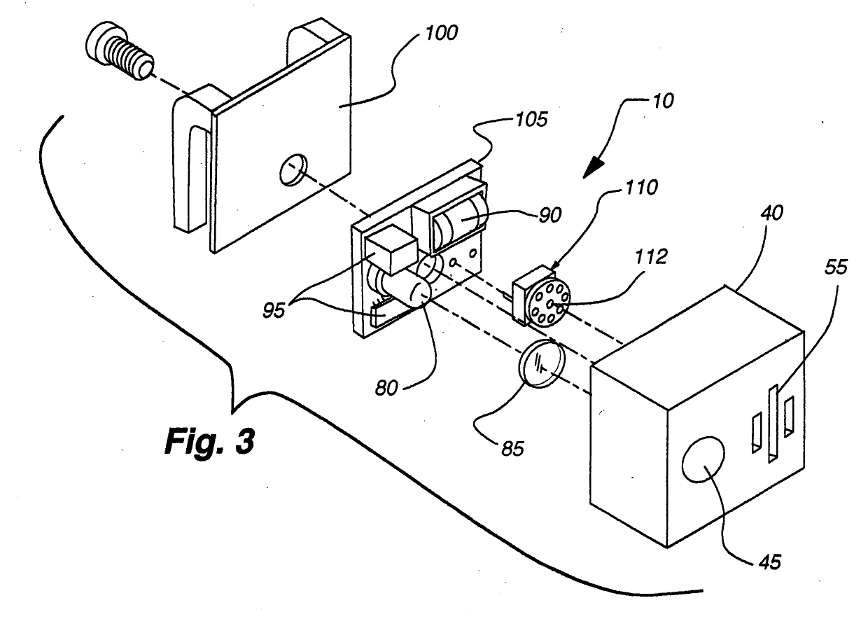

In FIG. 3, an exploded view of the device 10 displays at least some internal components of the device 10. The device 10 typically includes a housing 40, light emitting or producing unit 80, optional light cover 85, aperture 45, power source 90, optional control unit 95, and one or more connection points 50a, 50b. Housing 40 may include housing plate 100 for optional mounting and, in some embodiments, enclosure of internal components of device 10. Accordingly, an optional circuit board 105 is typically mounted to the housing plate 100 and may contain a power source 90, and circuits such as control unit 95. The circuit board 105 may interface with the light emitting unit 80. Circuit board 105 may be specifically made for operation of device 10 using readily available components. Additionally, a manual or remote power switch (not shown) may be provided with the device 10. Similarly, there are numerous configurations of and means of mounting or affixing the device components.

Still referring to FIG. 3, in the present embodiment of the present invention, an optional sound integration unit 110 is connected to circuit board 105 within device housing 40. The sound integration unit 110 typically includes a speaker 112 (such as a piezoelectric speaker) and related interface circuits for emanating one or more sounds, possibly in coordination with the projection of light. This may, for example, condition the pet to the projected light. Sound aperture 55 promotes the propagation of audio signals through the device housing 40. The sound integration unit 110 may also include a sound control to adjust one or more of volume, type, and clarity.

The light emitting unit 80 may interface with the control unit 95 and is powered by the power source 90. The light emitting unit or light producing unit 80 may be an LED, laser diode, infrared LED, incandescent bulb, or a similar component. Generally, the light emitting unit 80 projects a narrow beam of light to distances ranging up to three feet (or more, in some embodiments) or more from the device 10. Narrow beams of light may be obtained via a number of design options, such as using directional LEDs or laser diodes which inherently produce a relatively narrow beam of light. LEDs have bandgap energies corresponding to near-infrared, visible or near-ultraviolet light. A variety of LEDs which incorporate a dome-shaped epoxy encapsulant at their light projecting end promote focused visible light projection. Alternately, a reflective mirror or other structure designed to channel light, including one or more parabolic concave mirrors with the source of the light at the focus, may be used.

In one embodiment, a single LED is employed to produce a beam of light. However, in another embodiment of the present invention, multiple LEDs may be used. In either embodiment, one or more colored LEDs may be used.

The control unit (or activation circuit) 95 may provide switching functions and other light operation functions. The control unit 95 may be omitted in certain embodiments, or may have reduced or different functionality than is described herein. For example, the control unit 95 may be a simple switch. In one embodiment of the present invention, multiple lights are provided to enhance acquisition of pet interest. Control unit 95 provides numerous functions such as selecting, sequencing, randomizing light operation. Software or firmware may be implemented within control unit 95 to perform numerous operations, possibly including operator preferences. Embodiments of the present invention may utilize various semiconductors, memories, processors, controllers, integrated circuits, logic or programmable logic, clock circuits, and the like. For example, the control unit 95 may accomplish a variety of functions and features via switches, transistors, capacitors, and resistors or other electrical components, either alone or in combination. As used herein, the term “transistor” or “switch” includes any switching element such as, for example, n-channel or p-channel complementary metal oxide semiconductors (CMOS) transistors, metal oxide semiconductor field-effect transistors (MOSFET), field-effect transistors (FET), junction gate field-effect transistor (JFET), bipolar junction transistors (BJT), and so on. The particular type of switching element used may depend on the particular application of the circuit, and further may be based on factors such as power consumption limits, response time, noise immunity, fabrication considerations and so on.

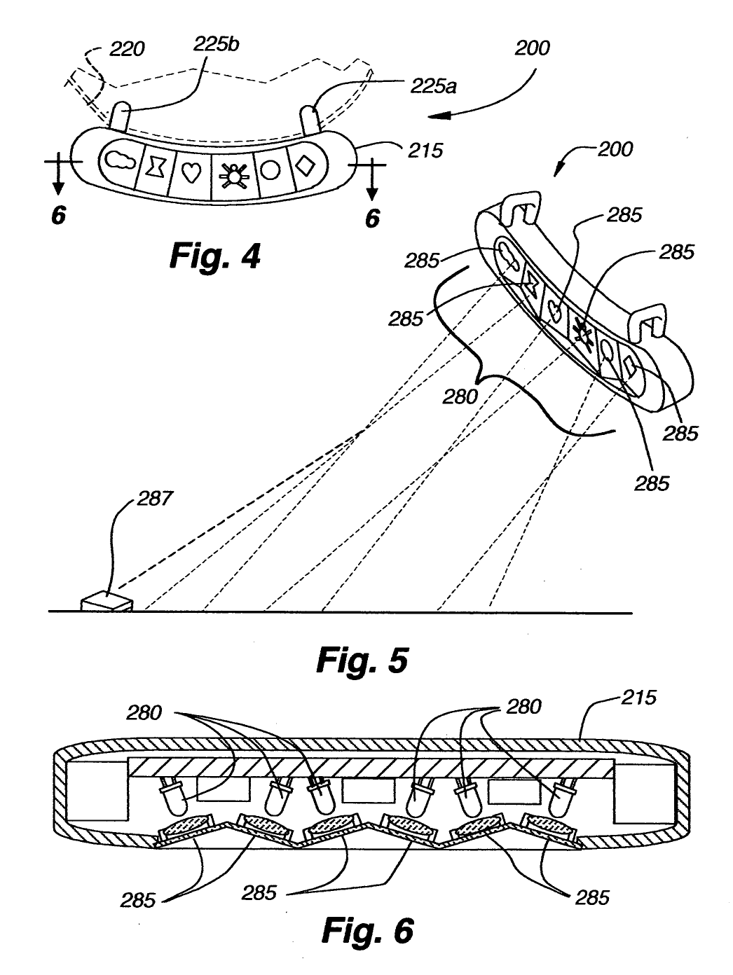

FIG. 4 shows another embodiment of the present invention, namely a device 200 with a curved flexible housing 215. The device 200 may be longitudinally affixed to a pet's collar 220. The housing 215 may be made of a suitable material, such as polyethylene or other flexible material, which provides at least some conformity of the device 200 to a pet collar 220. To aid in securing the device to a pet, connection points 225a, 225b may be provided. Connection points 225a, 225b may be located at various locations on surfaces of the device housing 215. In one embodiment of the invention, connection points 225a, 225b may be molded rings or padeyes attached to the housing appropriately sized for threading or feeding a pet collar therethrough. Flexible hooks or rectangular brackets may also be used for ultimately securing the device 200 to a pet or collar. Alternately, if the pet wears other types of animal attachment devices, such as harnesses, clothing, or backpacks, then different connection points may be suitably selected for the device 200. Accordingly, there are numerous designs or mechanisms available to employ for securing device 200 to a pet.

In yet another embodiment of the present invention, a weighting device (not shown) may be provided to orient the device 200, for example maintaining it below the animal's head. Such weighting devices may be a material added to the housing 215, for example. However, orientation of the device may be depend of the type of animal attachment device and its ability to be tightened such that orientation of the device is configured for projection of light from light producing unit 280 onto a surface visible to the animal.

Now referring to FIGS. 5 and 6, device 200 may project light from one or more light emitting units 280 onto a surface at different angles. Light emitting units 280 may be oriented at uniform or mixed angles. Lens or aperture covers 285 may provide angular optical direction of light in place of, or in conjunction with, the mounting of the light emitting units 280. For example, as shown in FIG. 6, light emitting units 280 may be angularly mounted within a device housing 215. Light is emitted through an aperture cover 285 which may modify the angle of light projection as well as alter the color or shape of the projected light. As better seen in FIG. 5, the aperture covers may take on the shape of insects, geometric shapes, patterns, or other shapes, some of which may entice a pet's interest. A controller unit (not shown) may, remotely or within the housing, controllably alter the selection of projected lights for possible viewing by the pet. Likewise, multiple light emitting units 280 may be activated simultaneously, creating numerous projected lights at once.

In still another embodiment of the present invention, the control unit may remotely operate device 200, and provides random operation of lights. The control unit also provides functions based on timing sequences, alternating operation of lights, or operator selection of individual lights. Remote operation of device 200 may entail use of radio frequency (RF), infrared (IR), or other communication frequencies. For instance, the device 200, via the control unit, may also be operated across a communication network coupled with one or more communication relay stations, such as a computer, telephone, or the Internet. In one embodiment, an operator may control the operation of the device and its one or multiple light emitting units via a phone system, thereby remotely exercising a pet. For example, an operator of the device 200 may telephone a location where the animal resides. An instrument receiving the call may identify and activate (or otherwise “wake-up”) the device 200. The device 200 may be further operated via software by a wireless transmission or other code to enable the operator to selectively operate the occurrence of the light projection, including whether one or more light emitting units are operated. Likewise, in any or all embodiments the operator may choose a random operation of the light emitting units to exercise or entertain the animal.

In another embodiment of the present invention, the control unit may interface with a proximity detector to detect the distance from the device to a nearby surface for determining whether light emitting unit 280 should be operated. Distances from the device 200 to a nearby surface may be calibrated with the control unit and proximity detector for optimum results. Effective distances may be determined by the choice of light emitting units and their associated power usage. Distance or proximity detectors are commercially available and vary in size, function, and cost. Such sensors may include ultrasonic sensors which employ transducers and timing circuits, camera sensors, laser interferometry, or infrared sensors which employ LEDs or laser diodes to compute distances via a phase shift of a modulation signal. Component size and circuit architecture, among others, may be considerations for incorporating a proximity detector within the present invention.

In another embodiment of the present invention, a proximity sensor (not shown) interfacing with the control (not shown) be used in conjunction with a proximity tag 287, where the proximity sensor senses the presence of the tag to determine whether to operate light emitting unit 280. This embodiment may provide a means of controlling a reaction to the device 200. Since some animals may respond to projected light in an erratic manner, an animal's unpredictable behavior may be tamed via a strategically placed proximity tag which may control operation of the light emitting unit. For example, an animal or pet approaching a strategically placed tag may result in turning off (or on) the device or disengaging the light emitting units 280 from operation. Tags 287, for instance, may be deployed at locations near a water bowl to prevent spillage, or a china cabinet to prevent undesirable damage. Thus, the control unit interfacing with the proximity sensor and tag 287 may provide a control for the operation of device 200. Proximity sensors and tags, or proximity systems, may vary in size, function, and cost. A proximity system may utilize a magnetic signature tag coupled with an electrical field, which uniquely identifies the tag with the field by means of sensitivity selection and calibration.

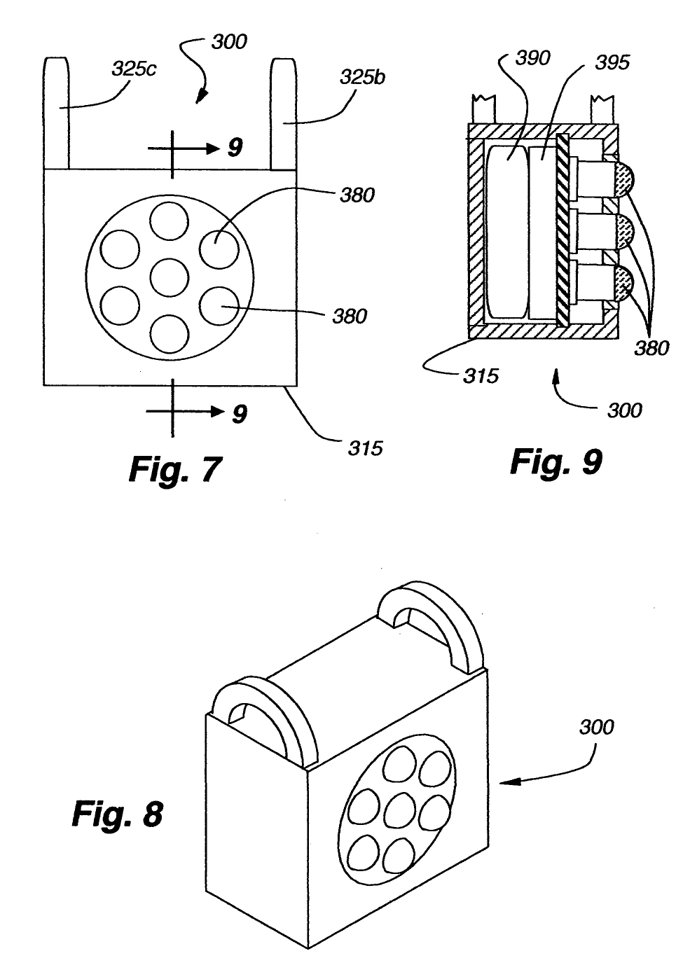

Referring now to FIGS. 7-9, yet another embodiment of the present invention is shown. In this embodiment, a plurality of light emitting units 380 may be provided within a device housing 315 having one or more attachment points 325a, 325b. As best seen in FIG. 9 (which is a cross-sectional view taken along line 9-9 of FIG. 7) light emitting units are operationally connected to a power unit 390, for example, via the operation control unit 395. The light emitting units 380 may be fixedly mounted within the device housing 315. In the exemplary embodiment, the light emitting units 380 are dispersed about at least one side of the housing 315, with each light emitting unit individually controllable by control unit 395. Again, selection of an individual light, randomized operation of alternate light emitting units, or a timed sequencing of light emitting units may be performed by control unit 395 within device 300. Alternative embodiments may omit the control unit 395.

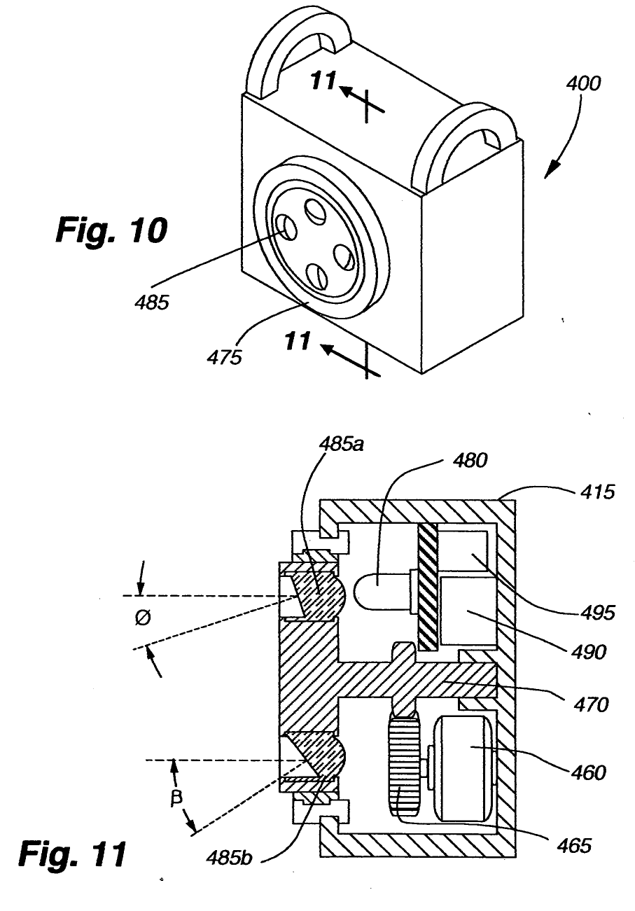

In still another embodiment shown in FIGS. 10 and 11, a single light emitting unit is implemented within a device 400. Multiple light colors, shapes, and angles of projected light may be produced. As best seen in FIG. 11 (which is a cross-sectional view taken along line 11-11 of FIG. 10), a single light emitting unit 480 is provided within the device housing 415, and is connected to control unit 495 and power source 490. The motor 460, in operation with control unit 495, may turn a gearing 465 and axle 470 which may be connected to a lens wheel or aperture wheel 475. The aperture wheel or selective lens unit 475 may include multiple aperture covers or lenses 485a, 485b, each designed to modify light produced by light emitting unit 480. For example, a first lens 485a directs projected light at an angle theta (θ) when aligned with the light emitting unit 480. By contrast, when a second lens 485b is aligned with the light emitting unit 480 by rotation of the axle 470, light may be projected at an angle beta (β). Thus, each angle provides an alternate position for a light projected on a surface.

Further, the various lenses 485, 485a, 485b may provide multiple colors and/or shapes for projected light. Rotation of the lens wheel 475 may be performed remotely, for example with a remote control. Thus, an operator of the device 400 via a control unit 495 may communicate an instruction to the control unit 495 to select a lens suitable to the situation or based on a projection of light into a pet's field of view.

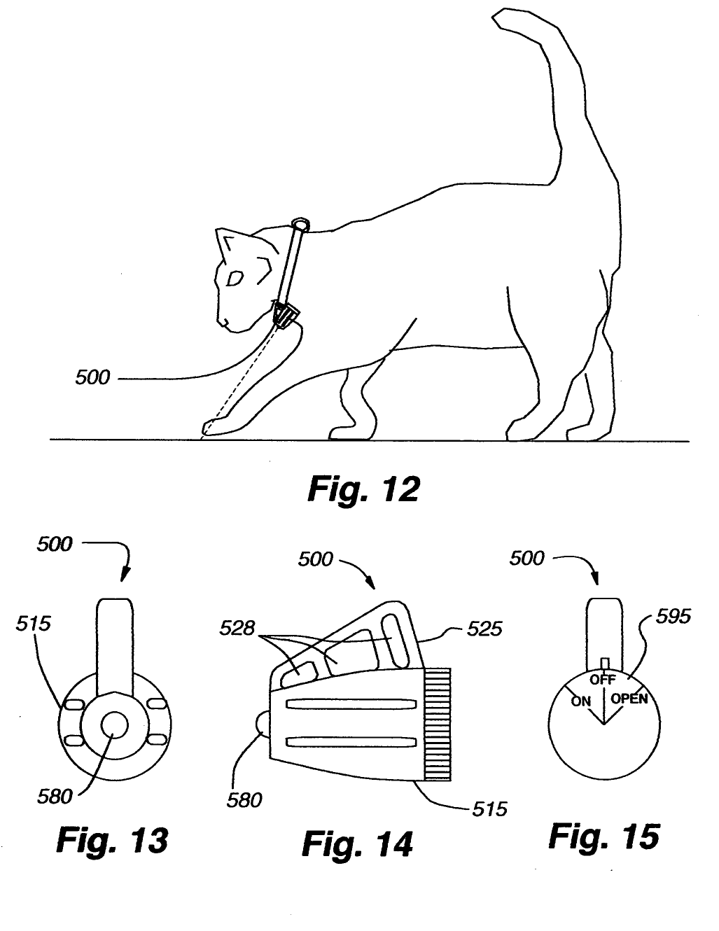

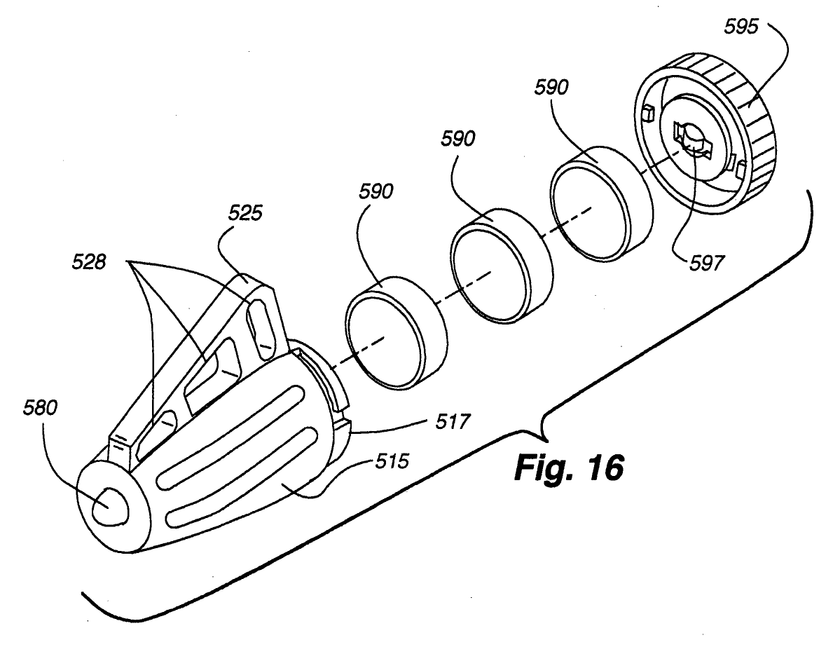

FIGS. 12-16 show yet another embodiment of the present invention. FIG. 12 depicts the embodiment in an exemplary environment. FIGS. 13-15 depict various view plan views of the embodiment. The device 500 includes a housing 515 which may have a conical or tapered shape. The device 500 typically includes a light emitting unit 580 to project a beam of light onto a surface. A control unit 595 may be provided in the form of a rotational switch for operating the light emitting unit 580. As best seen in FIG. 16, the control unit 595 may cover an opening for loading, unloading, and securing a power source 590 within the device 500. Affixed to the control unit 597, one or more electrical contacts may be provided to complete an electrical circuit within the device 500 to operate the light emitting unit. The control unit 595 may further engage the housing 515 via one or more moldings or connectors 517. Additionally, the embodiment may provide one or more angularly shaped connectors (see FIG. 16) 525 which may position the device 500 such that the light-emitting unit 500 projects the light onto a surface visible to the animal. Typically, this surface is below and slightly in front of the animal, as shown in FIG. 12. The connectors may further provide attachment to the animal via use of one or more connector apertures 528 (as shown in FIGS. 13 and 16). Each connector aperture 528 may provide alternate attachment features for removably securing the device to the animal, an animal's collar, or an article worn by the animal.

The present invention also generally includes a method of manufacturing an animal exercise device. The method includes providing a housing with at least one light emitting unit. Typically, such as those described herein, the light emitting unit is capable of projecting a light on a surface. The manufacturer may provide a connector to the housing and further affix the housing to a pet attachment device. The manufacturer may provide control of the light emitting unit, for example, to expose the projected light to an animal. While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

What is claimed is:

1. An illuminating device comprising:
a housing;
a light producing unit operably connected to the housing, operative to produce a light visible to an animal associated with the apparatus; and
an attachment device, the housing operably connected to the attachment device.

2. The illuminating device in claim 1, further comprising a control unit operably connected to the light producing unit.

3. The illuminating device in claim 2, wherein the control unit is a remote device controlling the light producing unit by an electromagnetic signal, the control unit further providing sequencing of light generated by the light producing unit.

4. The illuminating device in claim 3, wherein the control unit further comprises:
a switch operably connected to the light producing unit; and
a sound integration unit for conditioning the pet to light produced from the apparatus.

5. The illuminating device in claim 3, further comprising:
a plurality of light producing units, each light producing unit having an aperture and operably connected to the power source and each light producing unit angularly disposed about the housing; and
at least one attachment point operably connected to the housing for connecting the apparatus to the pet attachment device.

6. The illuminating device in claim 4, wherein the control unit further provides a sequencing of light based on at least one of a timed cycle, repetitive cycle, random cycle, and a targeted cycle.

7. The illuminating device in claim 5, wherein the sound integration circuit is selectively sequenced with an operation of the light produced.

8. The illuminating device in claim 6, wherein the housing is made of flexible material.

9. The illuminating device in claim 6, wherein the light producing unit is selected from the group consisting of light emitting diode (LED), laser, and infra red LED.

10. The illuminating device in claim 6, wherein the pet attachment device is selected from the group consisting of collar, article of clothing, harness, and backpack.

11. A animal exercise device comprising:
an animal collar;
a housing removably secured to the animal collar; and
at least one light emitting unit operably coupled to the housing, the light emitting unit operative to project a focused beam of light onto a surface.

12. The animal exercise device in claim 11, further comprising a power source operably coupled to the light emitting unit.

13. The animal exercise device in claim 12, further comprising an activation circuit for controlling the light, the activation circuit operably coupled to the at least one light emitting circuit for exposing an animal to the focused beam of light projected onto the surface.

14. The animal exercise device in claim 13, wherein the activation circuit is remotely connected to the animal exercise device and operative to selective sequencing of light control.

15. The animal exercise device in claim 14, wherein the selective sequencing of light is at least one of random, targeted, periodic, and timed.

16. The animal exercise device in claim 14, further comprising a weighting unit for orienting the animal exercise device.

17. The animal exercise device in claim 16, further comprising a proximity switch operative to a sensor, the sensor positioned adjacent to a stationary object, the proximity switch operably coupled to the activation circuit and the housing.

18. The animal exercise device in claim 17, further comprising a proximity sensor for detecting a distance of the surface, the proximity sensor operably coupled to the activation circuit and light emitting circuit.

19. The animal exercise device in claim 18, further comprising a removably secured aperture cover operably connected to the housing, wherein the aperture cover permits light to transmit and forms a two-dimensional shape of projected light on the surface.

20. The animal exercise device in claim 19, wherein the aperture cover produces a color of projected light.

21. A method of manufacturing an animal exercise device, comprising the operations:
providing a housing;
providing at least one light emitting unit operably connected to the housing and operative to project a light visible to an animal onto a surface;
providing a connector operably connected to the housing to attach the housing to an animal attachment device;
providing control of the at least one light emitting unit from the housing unit, thereby exposing the animal to the light projected onto the surface.

22. The method in claim 21, further comprising:
providing a sequencing unit operative to control at least one light emitting unit; and
providing a proximity module for determining whether to project a light from the at least one light emitting unit based on a predetermined distance to the surface.

23. A pet entertainment device comprising:
a pet collar;
a housing having at least one aperture, the housing removably secured to the pet collar; and
at least one light emitting circuit operably coupled to the housing, the light producing unit operative to project a focused beam of light onto a surface.

24. The pet exercise device in claim 23, further comprising a power source operably coupled to the light emitting circuit.

25. The pet exercise device in claim 24, further comprising an control circuit for controlling the light, the activation circuit operably coupled to the at least one light emitting circuit for exposing a pet to the focused beam of light projected onto the surface.

26. The pet exercise device in claim 25, further comprising a proximity sensor for detecting a distance of the surface operably coupled to the activation circuit and light emitting circuit, the distance calculated via a phase shift in a modulate signal produced by the proximity sensor.

27. The pet exercise device in claim 26, further comprising:
a selectable lens Unit operably connected to the at least one aperture and the at least one light producing unit;
a plurality of lenses operably connected to the selectable lens unit, each lens operative to modify light projection; and
a motor operably connected to the selectable lens unit and the activation circuit, wherein activation circuit positions a lens from the selectable lens unit to project a modified light.

28. The pet exercise device in claim 27, wherein a lens of the plurality of lenses modifies an angular direction of project light.

29. The pet exercise device in claim 28, wherein a lens of the plurality of lenses modifies a shape of project light on a surface.

30. The pet exercise device in claim 29, wherein a lens of the plurality of lenses modifies a color of project light.
